(19) United States
(12) Patent Application Publication
(10) Pub. No.: US 2025/0305818 A1
(43) Pub. Date: Oct. 2, 2025

(54) Vehicle Wheel Alignment via Sensor Fusion

(71) Applicant: Gyraline Corporation, Wilmington, DE (US)

(72) Inventors: Thomas Samuel Henao, San Antonio, TX (US); Harrison Tasos Geron, Orinda, CA (US); Jonathan James Buchanan, New Braunfels, TX (US); Richard Alan Soefje, Castle Hills, TX (US)

(21) Appl. No.: 18/771,067

(22) Filed: Jul. 12, 2024

Related U.S. Application Data
(60) Provisional application No. 63/572,041, filed on Mar. 29, 2024.

(51) Int. Cl. G01B 21/26

(52) U.S. Cl. CPC G01B 21/26

(57) ABSTRACT

Described herein are multiple embodiments of systems, apparatuses, and methods which enable a user to measure one or more different wheel alignment specifications, including at least camber, toe, caster, thrust angle, Ackerman, and/or perform a wheel alignment using the described novel handheld device and encasement.

### FIELD OF TECHNOLOGY

This disclosure relates generally to vehicle maintenance, particularly vehicle wheel alignments. Example embodiments refer to methods, apparatuses, and systems using an encased handheld electronic device, and no other device, such that the performance of vehicle wheel alignments can be completed and improved.

### BACKGROUND

Proper wheel alignment is all but required to ensure a vehicle performs optimally. Wheel alignment can affect tire wear and other component longevity as well as how a vehicle behaves when driven or operated. Further, wheel alignment can affect the efficiency of a vehicle.

A wheel alignment involves, in short, adjusting a vehicle's suspension and steering geometry such that the position and orientation of the wheels are within a desired range or at a particular value. This can include either statically, such as at ride height, or dynamically, such as throughout the cycling of a suspension or when the wheels are turned. There are numerous alignment parameters for wheel alignment known in the art, including camber, toe, caster, Ackermann, bump steer, thrust angle, and steering axis inclination, among others. Each of these parameters has a particular specification, such as a value(s) or range(s), set by a manufacturer or user, including due to an intended purpose of the vehicle at a particular time or use, and which may change depending on the intended purpose.

A vehicle's wheel alignment can be adjusted or altered in numerous ways, depending on the particular vehicle's design. A vehicle manufacturer may include components in the vehicle's design that allow for alignment parameters to be adjusted to the desired specification. For example, a suspension design can include the use of eccentric bolts, adjustable length rods, pivoting bushings or rod ends, spacers, shims, or washers, among numerous other known methods in the art to adjust the particular value(s) or range(s) for an alignment parameter.

There can be numerous reasons why a vehicle's alignment needs to be checked and adjusted. As one example, manufacturers may need to check or adjust a vehicle's wheel alignment on the assembly line even before it is delivered to a customer. Another example includes wherein the same chassis may be used with different suspension and steering components, which necessitates the need for a wheel alignment to ensure the vehicle is in conformance with the desired values or ranges for each alignment parameter. Other examples include that trims of the same vehicle may have different suspension components or even the same components but different alignment parameter specifications due to the different trim's application. Further, wheel alignments allow for discrepancies or larger tolerances in the manufacturing process of the chassis or vehicle which may affect wheel alignment. Further, even though manufacturers design vehicles with specific alignment parameters and attempt to deliver new vehicles with wheel alignments that match their design specifications, for numerous reasons, even new vehicles may have wheel alignments that are out of specification at first delivery.

Further examples include wherein the user of a vehicle may want to alter the specifications of the alignment parameters for particular purposes. For example, vehicles that are used for high-performance driving, racing, or due to stylistic reasons, may alter a wheel alignment outside of the manufacturer's recommended specifications for a particular purpose. This sometimes involves simply changing the values or ranges of the alignment parameters via the adjustability of the components provided by the manufacturer. It can also involve aftermarket parts, which can provide a further range of adjustability of certain alignment parameters. Further, modifications to a vehicle may also alter the specifications of the alignment parameters and the wheel alignment may need to be performed to adjust the specifications of the parameters to a desired value or range.

Finally, due to the nature of the use of a vehicle, wheel alignments should be checked and adjusted throughout the life cycle of a vehicle, at regular intervals, or after an event such as an accident or, for example, hitting a pothole. A wheel alignment can drift or be knocked out of specification for numerous reasons, such as wear on suspension or steering components or forces imparted on said components. As such, it is recommended to perform wheel alignment when changing the tires of a vehicle or at specific intervals.

However, wheel alignments are expensive and time-consuming both on the part of the consumer and the shop or business performing the service. Currently, performing an alignment requires the use of large, complicated machinery. For example, the state-of-the-art and industry-standard alignment machines at the time of invention require the use of a large central sensor and processing unit that weighs hundreds if not thousands of pounds and takes up the entire width of a vehicle shop bay. These systems also require the use of multiple large sensors and lasers or optical devices, which must be individually attached to each wheel, as well as a specialized vehicle lift. These tools are all expensive, complicated, and susceptible to damage and/or require frequent calibration to perform correctly, as well as are not space efficient. Repair shops commonly must devote an entire vehicle bay just to the alignment machine. Further, repair shops cannot afford to, or do not, keep these systems properly calibrated, and as such, the alignments are commonly not accurate. This is further exacerbated by the complex nature of the machines, requiring specifically trained expert technicians to perform alignments quickly, accurately and precisely, and the accuracy or precision of an alignment on such machines may be dictated by the skill of the technician. Other do-it-yourself alignment options at the time of invention involve numerous expensive components and often include strings, may require multiple operators, and other inaccurate and time-consuming methods and systems.

Thus, there is a need for an invention that efficiently and accurately accomplishes the desired task of performing vehicle wheel alignments with inexpensive and limited machinery, which is easy to use and resistant to damage and/or falling out of calibration. It is therefore an object of this invention to provide a device, system, and apparatus that may be used for performing such wheel alignments using such inexpensive and limited machinery.

### SUMMARY

The described invention provides multiple embodiments of methods, systems and apparatuses which allow one or more users to take a vehicle's wheel alignment.

A summarized example embodiment includes wherein a handheld electronic device with a particular set of sensors includes one or more protrusions, either as part of the device or an encasement, that terminate at a known disposition in relation to the device. The device, particularly the protrusions, can then be placed alongside one or more surfaces, such that the device's sensors can measure, calculate, and/or infer the disposition of the surface. Either through this, or multiple, measurements, calculations and/or inferences, a central axis or plane (centerline) of the vehicle can be determined. Then, further measurements, calculations, and/or inferences of further surfaces can be measured, for example the front face of a wheel, such that the alignment specifications for any alignment parameter can be determined. The device may then save, compare, display, or otherwise use the alignment specifications. This further use of the already determined specifications includes, for example, determining further alignment parameter specifications.

The inventions disclosed herein may be implemented in any means for achieving various aspects. Other features will be apparent from the accompanying drawings and from the detailed description that follows.

### BRIEF DESCRIPTION OF THE DRAWINGS

Example embodiments are illustrated by way of example and are not limited to the figures of the accompanying drawings, which, like references, indicate similar elements.

FIG. 1A is a component view of one embodiment of the present invention alignment system, apparatus and method, particularly the electronic device.

FIG. 1B is a component view of one embodiment of the present invention alignment system, apparatus and method, particularly the electronic device in an encasement.

FIG. 2A is a component view of one embodiment of the present invention alignment system, apparatus and method, particularly the electronic device with axes and planes.

FIG. 2B is a component view of one embodiment of the present invention alignment system, apparatus and method, particularly the electronic device in an encasement with protrusions and with labeled axes and planes.

FIG. 3A is a component view of one embodiment of the present invention alignment system, apparatus and method, particularly a vehicle with labeled axes and planes.

FIG. 3B is a component view of one embodiment of the present invention alignment system, apparatus and method, particularly a surface of a vehicle and the device's protrusions with labeled axes and planes.

FIG. 3C is a component view of one embodiment of the present invention alignment system, apparatus and method, particularly a surface of a wheel and the device's protrusions with labeled axes and planes.

FIG. 4A is a flow chart view of one embodiment of the present invention alignment system, apparatus and method.

FIG. 4B is a flow chart view of one embodiment of the present invention alignment system, apparatus and method.

FIG. 5A is a flow chart view of one embodiment of the present invention alignment system, apparatus and method.

FIG. 5B is a flow chart view of one embodiment of the present invention alignment system, apparatus and method.

FIG. 6A is a component view of one embodiment of the present invention alignment system, apparatus and method, particularly the electronic device with covers for the encasement protrusions.

FIG. 6B is a component view of one embodiment of the present invention alignment system, apparatus and method, particularly the electronic device with covers for the encasement protrusions.

FIG. 7 is a component view of one embodiment of the present invention alignment system, apparatus and method, particularly the electronic device in an encasement with protrusions.

Other features of the present embodiments will be apparent from the accompanying drawings and from the detailed description that follows.

### DETAILED DESCRIPTION

Disclosed are methods, apparatuses, and systems that may provide for the wheel alignment of a vehicle.

In one embodiment, which may be combined with any other embodiment, the wheel alignment may be performed on a passenger vehicle which has four-wheels arranged as two axles. The vehicle may also be of any other type, including but not limited to SUVs, light trucks, vans, and any other type of vehicle that would be known to a person of ordinary skill in the art to be a vehicle that would necessitate an alignment.

In other embodiments, which may be combined with any other embodiment, the vehicle can be any vehicle that has different numbers of wheels or axles, for example, a motorcycle with two wheels or a semi-tractor with ten wheels. Further, the vehicle the alignment is performed on may also have any type of propulsion system, including but not limited to gasoline, diesel, electric, hybrid or plug-in hybrid, hydrogen. Further, the vehicle may be unpowered, such as a trailer or any other wheeled apparatus. Note that the term axle is not limiting to that of a live or straight axle, but instead the configuration of wheels in sets or pairs, which is known to persons of ordinary skill in the art. Further, embodiments can include wherein the wheels are in any other configurations as well, such as dual rear wheel (DRW) or 6×6 configurations.

In other embodiments, which may be combined with any other embodiment, the vehicle may include systems that do not involve wheels. This can, for example, be tracked vehicles such as tanks or snowmobiles as well as other methods of vehicle-ground interfaces such as vehicles with skis or sleds. As a further example, this may include vehicles such as airplanes with wheels or skis. Another example includes motorcycles, bicycles and other two wheeled vehicles. Vehicles can be aligned specifically to their vehicle type. For example, motorcycles can be aligned wherein the rear wheels are aligned in respect to the chassis and the front wheel to the thrust line. It is readily apparent how this invention can be applied by a person of ordinary skill in the art to the principles of aligning any vehicles in addition to a standard four-wheel, two-axis vehicle.

Further, in an embodiment, which can be combined with any other embodiment, instead of the wheels being aligned, the hub, brake disc or any other component of the vehicle can be aligned using the principles described herein.

The wheel alignment system may be capable of measuring, calculating, or inferring, as well as allowing for a technician to adjust, at least the following alignment parameters which are known to be a person of ordinary skill in the art at the time of invention: camber, toe, caster, Ackermann, bump steer, thrust angle, steering axis inclination, scrub radius, among others.

An embodiment, which may be combined with any other embodiment, the present invention is a system, method and/or apparatus which provides for one or more users to perform a wheel alignment. This may involve measuring and adjusting particular alignment parameters such that the parameters meet certain specification value(s) or range(s).

An embodiment, which may be combined with any other embodiment, the system, apparatus, or method may include one or more of the following components in addition to that of the vehicle and its wheels (or component(s) to be aligned), all of which form the object of the invention: an electronic device including sensors such as an accelerometer and gyroscope with proprietary software installed; a particular encasement for the electronic device with the features herein described; further measurement devices, such as rulers, levels such as a spirit level, wheel turnplates with angle markings; or other remote sensors with features herein described.

The electronic device in a preferred embodiment may be any mobile handheld device, such as an off-the-shelf smartphone or tablet running iOS, Android, or any other operating system, including a proprietary or open-source operating system, such that the proprietary software and graphical user interface (GUI) described herein can be operated. In other embodiments, the handheld device can be a proprietary device with or without an operating system but able to display a GUI or any other method known by persons of ordinary skill in the art.

An embodiment, which may be combined with any other embodiment, the electronic device can include one or multiple screens or displays, wherein the screens and displays can be of any type, including LCD, OLED, AMOLED, or any other type. In one or more embodiments, which may be combined with any other embodiment, the electronic device can include one or more segmented displays, such as to display respective alignment parameters and their specification value(s) or range(s). In one or more embodiments, which may be combined with any other embodiment, the device can stream or otherwise make either the proprietary software and/or GUI viewable or the underlying data available on another screen, device, or multiple other devices. This also includes wherein the device streams or makes available particular data or outputs, including sensor data.

The electronic device can include any number of sensors, but at least one of the following: accelerometer, gyroscope, gyrometer, compass, magnetometer, camera, barometer, pressure sensor, hall sensor, proximity sensor, lidar, camera, sonar, ultrasonic, and GPS sensor.

It can be understood herein that when the device takes a measurement using its sensors, it is using the sensor to determine the disposition of the sensor, motherboard or device in 3D space. This includes the device angle in any axis as well as location. Specifically, this may involve the gyrometer or gyroscope and accelerometer, but also may include any other sensors separately or together. For example, the device may have any axis sensor set or suite such as a 3 axis, a 6 axis, a 9 axis, or 12 axis, wherein the any number of sensors may make up the set or suite, including wherein the sensors may be two or more of the same type, different type, or any number of permutation of the same or different sensors. Further, the absolute axis of each and any of the sensors may be of any orientation or relative difference to each other, and may be known, unknown, or may be able to be calibrated by a user.

Further, the term disposition in this patent can be used to describe a distance between two elements, such as components, planes, points, axes, etc.; an absolute or relative angle between the two elements, such as the relative difference in a particularly 2D plane or plane of reference; or both the distance and angle between the two elements. Further, the term disposition can also include the orientation of any one of the elements. For example, “measuring the disposition” can include knowing, measuring or calculating that the center point of the handheld device is 5 cm from the plane created by the encasement protrusions, and thus the plane of the front surface of the wheel which the encasement protrusions are touching is 5 cm from the center point of the handheld device, and further knowing that the plane is at a particular angle, in any number of axes, to that of a particularly relevant plane of the handheld device. Thus, any plane or point can become known in 3D space in relation to any number of points, planes, or axes of the device. These terms can also be inclusive or replaced by terms that a person skilled in the art would understand to be degrees of freedom such as roll, yaw, pitch, forward, back, left, right, up, and down, as well as any other number degrees of freedom, including any number of n degrees of freedom and any similar terms or understanding a person skilled in the art would understand to be relevant or applicable to locate the disposition of any number of elements in 3D space to any other points, planes or axes, as well as the orientation of each of those elements. Additionally, the disposition can be in relation to or absolute to that one or any of the elements. For example, the disposition can be relative to the sensor itself, to a point on or in the sensor, a point on or in the device and/or a point on or in the encasement, among any other combination. Further, disposition can be inferred or calculated wholly, or in part. For example, a sensor can have a known relation to a device, such that the yaw, roll, and pitch of the device can be inferred from the sensor's yaw, roll and pitch even if the absolute orientation of the sensor and device are not the same. This can also be predetermined or can be calibrated by a user such as wherein a user orients the device in a known plane in a prior calibration measurement.

It can be understood herein that when the device takes a measurement using its sensors, that this may include reading the data of the sensors directly, or through any filter, either as a single data point, a string of data points, or continually and at any rate (Hz, etc.). For example, when the device takes a measurement, it may be reading the data of the gyroscope to understand the disposition of the device in 3D space. This can also include wherein the device then may compare the data to that of other data stored, previously taken, or entered by the user. For example, the device may have taken a first measurement using the gyroscope, and then subsequently a second measurement such that the first and second measurements can be compared to produce a difference in disposition, such as a difference in angle in the vertical plane.

In an embodiment, which can be combined with any other embodiment, the rate of measurement can be automatically or manually adjusted. For example, the user can manually adjust the rate or can change a metric for the automatic adjustment of the rate, such as sensitivity or thresholds. The automatic adjustment of the rate can also be preset. Further, the automatic adjustment of the rate can include any type of logic, and any number of types of logic, including machine learning or AI, and can include any data input, including from the same or other sensors to determine the proper adjustment of the rate. Manual or automatic adjustment can set the rate to a particular value or to a range. Further, the rate can be adjusted at any level such as at a sensor data level, calculation level, or display level and can be done individually or to any number of sensors and/or at any number of levels, including where the data from multiple sensors has been combined. Further, the manual and automatic settings can be changed through a GUI or other interface.

Further, it can be understood that the measurement can also include continuous measurements. For example, when the measurement of a first surface is made, the device can then continually measure, track or otherwise compare data from the sensors until a second or any other number of surfaces are measured. This can include, for example, where the device continually takes measurements to be able to keep the device's disposition known at any point or time. This can help reduce sensor drift or provide sanity checks.

Further, it can be understood herein that when the device takes a measurement using its sensors, it may be reading the data of multiple sensors. The data from each sensor may be stored, viewed or otherwise used individually, or the data may be combined together such as to make a reading more accurate. For example, when the data of the gyroscope is measured, the accelerometer can be used to augment the data from the gyroscope, such as to make the data more accurate. This can include, for example, sanity checks or filtering, but also may be fundamentally a part of the measurement or calculation to understand the disposition of the device or the particular parameter being measured. For example, the gyrometer and accelerometer data can be used together to determine the device's disposition in 3D space. This can also be coupled with the aforementioned continuous measurements, where the same sensor, or any other sensor or sensor data, can be continuously measured and be used to sanity check, filter or otherwise be used for a purpose, such as if the measurement goes out of range.

In one or more embodiments, which may be combined with any other embodiment, when a sensor data from a particular sensor and sensor data goes into a certain range, or out of a certain range, or otherwise is desired or set, other sensors and sensor data can be used to increase the accuracy or precision for the particular sensor and sensor data, or can be used for sanity checks or filtering. In other embodiments, the other sensors and sensor data can replace the particular sensor and sensor data.

In one or more embodiments, which may be combined with any other embodiment, the device can use any sensor data to help reduce outlier data for the same sensor and sensor data, or any other sensor and sensor data.

In one or more embodiments, which may be combined with any other embodiment, the device can use any sensor data to abort any measurement or inform the user that a measurement needs to be retaken, redone, or recalibrated or that such measurements or data are inaccurate. This can include wherein the data can be used to weight or otherwise modify other data.

The device can give any number or type of feedback to the user. This includes, for example, at least using the device speaker, vibration, haptic feedback, flash or any other lights, or by pushing a notification on the device or to any other device. For example, if the gyroscope or accelerometer senses a shock that may affect a gyroscope reading, the device may beep notifying the user that a particular measurement needs to be retaken. This may be in conjunction with, for example, a message on the GUI or any other interface being used.

An embodiment can also for any measurement, specification, sensor input, calculation, parameter or other value or range in its memory or processor, determine, measure or infer a confidence interval, error measurement, drift value, accuracy, precision, or any other meta data or data modifier or attribute. Then if that particular value or range is met, and/or corresponding or related other numbers also, reach a particular value or are in or out of a particular range, the device can perform an action depending on the application. For example, an embodiment after setting a measurement of a vehicle surface, may make more than four rotations and/or three minutes may lapse which then leads the calculation of error to become out of bounds, or the accelerometer senses a shock over a certain limit. The embodiment may then inform the user to retake one or more surface measurements. Other embodiments may inform the user that the measurements have a likelihood or degree of error, or may save the error values, ranges or indications alongside the measurement data. Further, embodiments may delete, weight, modify or otherwise discount further measurements or measurements that are associated with the error. This error may be calculated at any level of the data or calculations, such as based on the raw sensor data or may be calculated based on further calculations which involves multiple inputs.

Any embodiment can include any user inputs, including touch, typing, gestures, or voice or sound input. Further any embodiment can also include the ability to be controlled via another device, whether as an input or via emulation or virtual control.

In some embodiments, which can be combined with any other embodiment, the user interface and device can be run on or display on any virtual reality (VR) or augmented reality (AR) device. For example, the GUI can overlay on an AR device worn by the user which can indicate the alignment parameter specification to the user while they are actively adjusting such parameters on a vehicle. In other examples, the GUI can overlay on an AR device a live readout of the current values or ranges of the alignment specification as they are being adjusted, including indicating to the user that the values are in or out of range and the adjustment, or direction of adjustment necessary to reach the particular alignment parameter specification. This can include any type of notification or read out. For example, the AR device can tint a user's vision red or green to indicate a particular value has been reached or has not been reached. As a further example, the indication can be via a single green spot in the user's field of view when the user has reached a particular value, or for instance can overlay a green arrow or checkmark. In an example the arrow can indicate which way an alignment parameter specification needs to be changed.

The interface(s) may also walk a user through the alignment, such as guiding a user to a particular wheel and providing instructions or guides to carrying out any measurement or adjustment. Further, the interface may also communicate instructions to the user such as that a particular alignment parameter needs to be increased or decreased, such as that toe needs to be increased. This may include wherein the device knows or has access to data indicating the vehicle's suspension geometry and otherwise guides the user in modifying or adjusting the suspension such that the specification is reached.

In some embodiments the interface can include a wearable device. The wearable device can provide any type of notification to the user such as GUI display, particular color LED or display, a vibration, buzzer or beeper, or any other type of notification. For example, a smart watch can be connected to the device and the watch can vibrate when a particular measurement has been completed, or for example as the user changes the suspension geometry, a particular specification has been reached or a range or value has been met. The notifications can also guide the user in adjusting the suspension. For example, two quick vibrations can mean the camber is still too negative and two slow vibrations can mean the camber is still too positive.

An embodiment, which may be combined with any other embodiment, the encasement for the electronic device can be such that it securely encases the electronic device. The electronic device may be fastened or otherwise captive to the encasement. For example, the encasement can have a mechanism such as a captive screw which tightens down on the electronic device. The encasement can also include embedded or otherwise affixed, such as adhesive, material which grips or reduces movement of the encased device relative to the encasement and also keeps the device at an ideal placement within the encasement. The material can be of any type, such as rubber, silicone, Teflon, foam or plastic. For example, therein may be groves on the interior of the encasement, wherein silicone can be placed into the grooves, such that the silicone contacts the device when encased and reduced the movement of the device. Further, on the corners of the interior of the encasement, Teflon spacers, rub rails, or gaskets may contact the encased device such that the movement by the device is reduced and the device in held in an ideal position. Further, these materials may be removeable or replaceable.

In other embodiments, which may be combined with any other embodiment, the encasement can fasten or otherwise captivate the device via friction fit, elastic bands, clips or clip in, or wherein the device is fully encased in the encasement such as a two or more piece clamshell design. The encasement can be made of any material, including plastic, metal, silicone or any other material. Additionally, the encasement may be CNC'd, casted, injection molded, 3D-printed or made via any type of additive or subtractive manufacturing processes.

An embodiment, which may be combined with any other embodiment, includes wherein the encasement may be shaped or formed such that one or more planes are created by an exterior surface of one or more sides of the encasement. The exterior surface can be shaped or formed such that the part of the exterior surface that creates the one or more planes can run a portion of or the entire length of any one of the sides of the encasement at any thickness or height. The one or more planes may be of any disposition (i.e. angle and/or distance) relative to the encased device, respectively.

In another embodiment, which may be combined with any other embodiment, the one or more planes may be formed by one or more protrusions from the encasement that terminate at the one or more particular planes. In some embodiments, which may be combined with any other embodiment, there may be any number of protrusions such that any number of different planes may be created.

In another embodiment, which may be combined with any other embodiment, the protrusions may also be adjustable in terms of disposition, angle, and/or distance on any axis in relation to the device, encasement, or one another. An embodiment may include wherein the protrusions can be adjusted in length in a lateral, longitudinal and/or vertical direction in relation to the device and/or encasement, individually or together. This in turn allows the planes created by the one or more protrusions to be adjusted in disposition to the device, encasement, or one another.

In some embodiments, which may be combined with any other embodiment, for each of the one or more planes, or for multiple, all, or any, there may be a known value of a particular angle or distance from another point or points of the encasement or the encased device. For example, two protrusions on one side of the encasement may terminate at a shared particular plane, and that particular plane is known to be three inches from the center longitudinal axis of the encased device. In another embodiment that particular plane may be known to be offset 20 degrees on the longitudinal axis from the encased device. In other embodiments, there may be any known relationship to any single or multiple known axis, plane, or point of the encased device, respectively.

In some embodiments, which may be combined with any other embodiment, the device with encasement may include two protrusions offset radially by 180 degrees such that the protrusions create a plane in respect to one side of the device. Therein, the device with encasement may be placed or situated such that the plane created by the protrusions intersects with a plane created by a face of the wheel, and where the protrusions can be adjusted in length in both the longitudinal and lateral axis in relation to the device, such that the device is centered in respect to the face of the wheel and/or the protrusions can match a particular plane of the wheel without interference. Another example can include wherein there are three protrusions spaced radially by 120 degrees.

In an embodiment, which may be combined with any other embodiment, the measurement of the wheel (or wherein the element to be measured is something other than a wheel, such as a track) can be of any other part of the wheel other than the face of the wheel, such that the desired plane of the wheel can be measured. For example, instead of the front face of the wheel being measured, an interior spoke or spokes can be measured. In other embodiments, the back side of the wheel can be measured. This may also be for ease of measurement, or for more accurate measurements, such as if a particular surface on the wheel may be aligned or at a known disposition to the rotational axis of the wheel.

The location of the measurements on the wheel's surfaces can be particularly chosen to reduce error, such as due to ease of measurement, known flat surfaces or surfaces with a known disposition, or may be geometrically advantageous, such as where the particular surface reduces cross measurement or errors. For example, the protrusions may contact the wheel at opposite ends of the wheel across the centerline such as at the 3 and 9 o'clock positions.

In some embodiments, which can be combined with any other embodiments, the protrusions can be made of a different material than the encasement. For example, the protrusions, or portions of the protrusions can be made of a soft plastic, rubber, or other material such that when they contact a surface such as a vehicle panel surface that is painted, or the surface of a wheel, the contact will not scratch the surface. Further, the material can be selected such that material has a higher coefficient of friction and/or provides high grip between the portions and the surface being measured such that when the protrusions contact the surface, the encasement and the surface can be kept more easily stationary relative to each other.

In some embodiments, which may be combined with any other embodiment, therein may be an adapter which may be permanently or removably attached to the surface to be measured (such as anywhere on the vehicle body or the wheels) in any location and by any method including but not limited to screws or bolts, magnets, clamps, friction fit, keyed, or otherwise placed. This adapter can then allow for the repeatable, accurate and/or precise placement and/or placement of the encased device in relation to the surface or specification to be measured. This can be accomplished where the adapter and the encased device can key or otherwise nest into each other, such that their relative positioning is repeatable. For example, the adapter can have a keyway or cavity wherein the protrusions of the encasement can slot into. In other embodiments there may be markings on the encasement or the adapters which aid in alignment. The adapter can be made of any material, which may be different or the same as the encasement. In embodiments the adapter is placed in a fashion that allows the placements of the encased device in a known relation to one or more planes of the surface to be measured, or of the wheel(s) or vehicle, such as the center plane of the vehicle. In another embodiment, the adapter may instead be permanently or removable attached to the encasement and provides similar functionality and is accomplished similarly, as described herein.

In some embodiments, which may be combined with any other embodiment, the adapter may be formed such as to match a particular geometry of the vehicle such that the adapter keys in, slots, or otherwise can be placed in a particular position for the particular vehicle.

In some embodiments, which may be combined with any other embodiments, the surface to be measured, such as the panel of the vehicle or wheel can be fashioned to include such a geometry to allow the easy and repeatable placement of the protrusions or adapter. This can include for example the door sill of a vehicle having an indent at particular distance and placement such that the protrusions of the encased device or adapter key into the indent. This geometry may be fashioned at the time the vehicle is manufactured or may be added later, for example by a consumer and user of the described herein system-such as the use of a drill or punch and hammer. In other embodiments, which may be combined with any other embodiment, the placement can instead of a geometry, be marked with a sticker, pen or other marking for contact by the protrusions or adapter.

In some embodiments, which may be combined with any other embodiment, the protrusions may be fashioned such that a sleeve or cover can be placed over the protrusions for a desired purpose. This purpose may be such as to reduce scratches on the surface to be measured as described herein. Other purposes may be such to increase the grip between the protrusions and the surface to be measured; decrease, reduce, or eliminate the wear on the encased device. The sleeves or covers can be made of any material, but for example can be made of polyolefin or thermoplastics. The covers or sleeves can slide over the protrusion and be affixed by glue, friction, or for example by the thermoplastic shrinking over the protrusion. The thickness of the cover can be known such as to adjust any measurement parameters and be cut, fashioned, or applied to reduce any measurement error, such as wherein the relationship of a particular plane of contact point on the protrusion is not altered in relation to the surface to be measured.

In some embodiments, which may be combined with any other embodiment, there may be two sets of protrusions, wherein each of the sets are on opposite sides of the device, such that when taking measurements of the vehicle or wheels, the device does not have to be rotated in order to take measurements in reference to the ground, vehicle, or both. This can reduce error because it will limit the rotation or movement of the device in subsequent measurements. For example, with protrusions on the opposite sides of the device, if the device is oriented such that it is being held flat in reference to the ground and parallel with the center axis of the vehicle, wherein the top of the device is held pointing in the same direction of the vehicle, then the left side protrusions can measure surfaces on the right side of the vehicle, and then the device can be minimally rotated when the user goes to the left side of the vehicle, such then the protrusions on the left side of the vehicle can be taken with the protrusions on the right side of the encasement or device. As discussed elsewhere herein, the device can indicate to the user if the device has been rotated or moved too much or too sharply and may also indicate to the user which side of the device or which protrusions to use for any particular measurements. As also discussed herein, these rotations or movements, or lack thereof, can be in any axis.

In some embodiments, which may be combined with any other embodiment, the one or more planes may be each disposed at a known angle in relation to the encased device. For example, a particular plane may be known to be exactly parallel with the longitudinal axis of the device, or for example, parallel with the front face of the encased device. In other examples, the disposition of the one or more planes may be at a known disposition from the encased device's motherboard, any board that houses any of the aforementioned sensors, from one or more of any sensors, or any particular point or points of the device or encasement.

In some embodiments, which may be combined with any other embodiment, the angle of a particular plane created by one or more protrusions relative to the encased device may be known together with the distance from the encased device of the particular plane created by one or more protrusions. In other embodiments, which may be combined with any other embodiment, only the angle and not the distance is known. Further, in other embodiments, which may be combined with any other embodiment, the distance is known and not the angle.

In some embodiments, which may be combined with any other embodiment, the known distances and relative angles of the one or more protrusions may be previously determined and/or calibrated prior to purchase by the user. In other embodiments, the disposition may be determined or calibrated by the user after purchase. For example, the encasement of the device may introduce an error due to the device's placement in the encasement having tolerance, fit or finish, or the device's motherboard or components. This includes wherein the sensors may not be perfectly aligned with a device's axes or may not be, either through design or manufacturing error or processes, perfectly matched with a known axis or plane of the device. In another example this may be for instance because users are using different electronic devices or encasements. The system may be able to adjust or be calibrated for this, as discussed herein, such as to reduce error.

For example, the device can be calibrated by taking a measurement of a surface from a known surface of the device and then the device can be placed in the encasement, and the same surface can be measured again, such that the disposition of the plane created by the protrusions of the case in relation to the device and/or sensors can then be known. This can include one or multiple repetitions of measurement and/or using one or more sensors to achieve the result.

In another example, this can include taking an initial measurement such that the measurement sets the zero for all future measurements, and the disposition of future measurements can be compared, calculated, measured or inferred from this zero measurement. The zero measurement can include any number of sensors' data and may also involve multiple measurements such as to reduce or filter error.

In some embodiments, which may be combined with any other embodiment, the device may be positioned, held to, placed, or via other methods, set to measure, calculate, or infer a surface of a wheel or vehicle. The device, when put into such a position, may use the device's sensors to understand the disposition the plane created by the device or encasement, which then allows the disposition of the measured surface to be known since the disposition of the plane created by the particular surface of the device or encasement is known in relation to the device. The sensors used may include at least one of the gyroscope or gyrometer, accelerometer, barometer or any other listed sensor herein.

For example, in some embodiments, which may be combined with any other embodiment, the device can be positioned by a user such that one or more protrusions, which create a plane at a known disposition to the device, touch a surface of the vehicle, such that then the device can measure and impart the plane created by the protrusions to that of the surface of the vehicle. This process can also be imparted to that of a wheel, wherein the device can be positioned by a user such that one or more protrusions, which create a plane at a known disposition to the device, touch the surface of the wheel, such that then the device can measure and impart the plane created by the protrusions to that of the surface of the wheel.

In other embodiments, which may be combined with any other embodiment, the surface of the vehicle can be, for example, surfaces of the vehicle which are known to be parallel to the forward direction of the vehicle. Others can be, for example, surfaces of a wheel that are known to be perpendicular to the rotational axis of the wheel. In other embodiments, which may be combined with any other embodiment, the surfaces can be of any known disposition, angle, or direction in relation to the forward direction of the vehicle. Further, the surfaces described herein can be portions of the vehicle or wheel of any disposition. The surface measured can be at a known place or disposition on the vehicle, and the known place or disposition can be aided by the use of the device and/or encasement. For example, when measuring a vehicle's surfaces, the device with encasement can be placed alongside the bottom back edge of the window such that the protrusion touch or key into the back corner of the window, this then allows for an ease of measurement on the vehicle on both sides of the vehicle in the same corresponding location, which increases accuracy. Another example can be at a particularly identifiable panel indent or gap.

An embodiment of the invention, which may be combined with any other embodiment, can also include wherein a particular point on the vehicle, such as on the chassis but can be anywhere else, is accurately measured as one of the vehicle's surfaces and can be known in relation to the rest of the vehicle. Then, the same corresponding point or points for a corresponding measurement, including the exact same point, on the other side of the vehicle can also be accurately measured. Therein components such as, but not limited to, a sticker, sticker component, metal or plastic component with adhesive, bolt, clamp, components with a bolt or clamp, component with a magnet, or simply an indent of the surface, can be placed such that the known measurement points become repeatedly known. The component can also be formed such that the protrusions of the encasement key into a cavity or indent on the component or surface. Thus, this can increase the accuracy of a measurement of the surfaces of the vehicle. These known points can be particularly chosen in respect to their ease of measurement, placement of the device, or their disposition to the vehicle such as a known parallel location to that of the forward direction of the vehicle, or unlikelihood that the point has or will be damaged or otherwise altered from damage, use, or error in manufacturing of the vehicle. Further these points may be included in a database from the manufacturer of this invention and recommended to the user depending on the vehicle.

In some embodiments, which may be combined with any other embodiment, the surface of the vehicle can be exterior to the vehicle such as windows, door planes, body panels, chassis or frame rails. In other embodiments, which may be combined with any other embodiment, the surfaces instead may be interior to the vehicle or at any other point of the vehicle. Other embodiments, which may be combined with any other embodiment, can also measure surfaces and points not on the vehicle but instead in any environment, for example, a wall, the ground, or, for example, a surface of a car lift.

In some embodiments, which may be combined with any other embodiment, a particular plane can be measured via building an array to index using multiple measurements. For example, the encasement with device can be placed on a surface to be measured, or on a flat surface that is placed on the surface to be measure in order to reduce the variation in the surface to be measured, wherein the device then takes multiple measurements when the device is in more than one position (such as via rotating), such that the sensors and device are able to determine the particular plane in relation to the surface being measured.

In one or more embodiments, which can be combined with any other embodiment, the encasement and device can include provisions to mount the device to the surface to be measured. This mounting may hold the device at a particular disposition to that of the surface to be measured. For example, the device can be mounted to that of a wheel, such that the device can constantly measure or infer the disposition of the wheel in relation to the device.

In embodiments, which may be combined with any other embodiment, the measurements of the surface or wheel can be accomplished with or without an encompassment and with or without protrusion, such that a measurement of the surface of the vehicle can be calculated as described herein with or without the encasement.

In one or more embodiments, which can be combined with any other embodiment, the device is capable of measuring, calculating, and inferring the central plane or axis of a vehicle. For example, the device, through the aforementioned sensors, is able to be placed such that one or more surfaces of the vehicle are measured, and from these data points, the central plane or axis of the vehicle can be determined. One example can include wherein a surface on the chassis, which is known to be parallel to the vehicle's direction of motion, can be measured and determined to be the central plane or axis of a vehicle. Another example can include wherein the surface is a door or window panel, which is known to be parallel to the vehicle's direction of motion, can be measured and determined to be the central plane or axis of a vehicle. In other embodiments, which can be combined with any other embodiment, the surface measured can have a known relationship to the central axis or plane of the vehicle, such as a rear or front window or surface on a bumper is known to be perpendicular to the central axis or plane of the vehicle.

In one or more embodiments, which can be combined with any other embodiment, one or more surfaces of the vehicle which have a known value to the center axis of the vehicle, are measured, and the relationships between each of the surfaces can determine the central axis or plane of the vehicle. In one or more embodiments, which can be combined with any other embodiment, one or more surfaces of the vehicle which have an unknown value to the center axis of the vehicle, are measured, and the relationships between each of the surfaces can determine the central axis or plane of the vehicle. For example, whether the value between the surface and the center axis of the vehicle are known or unknown, the relationships between each of the surfaces can determine the central axis or plane of the vehicle. For example, the windows or door panels of a vehicle may not be parallel to the central plane or axis of the vehicle and instead are at an unknown angle. However, the window or door panels on opposite sides of the vehicle may have the same difference in angle with respect to the central plane or axis. As such, one or more measurements on each side of the vehicle can be taken so that the central axis can become known.

In other embodiments, which may be combined with any other embodiment, the surfaces measured may not be perfectly aligned, such as due to design, manufacturing errors of the vehicle or because, for example, windows or hinges are not perfectly aligned or may move in the life of the vehicle. This can be solved by taking multiple measurements of multiple surfaces on the vehicle, such that the data can be manipulated, including averaged, wherein the error introduced by such imperfection can be mathematically reduced or removed. This can include using mathematical statements such as averages, root mean square, or other statistical or calculation methods. The error reducing calculation can be taken at any step and between any measurement or determination. In a simple example, two measurements can be taken of a surface on the chassis, such that the two measurements are averaged to directly determine the central axis or plane of the vehicle. Other examples can be more complicated, for example, an embodiment can include taking two measurements on each side of the vehicle where each sides' measurements can be averaged before comparing it to that of the other side's measurements, which in turn have also been averaged, when determining the central plane or axis. In another embodiment the error reduction can be taken at any level and to any number of levels of measurements or calculations, such as when comparing or averaging to that of a third or additional number of surface measurements. This difference may be constantly calculated or may be calculated at a particular time, such as when taking the measurement itself.

In some embodiments, which can be combined with any other embodiment, the deviation of different measurements may be known, calculated or estimated and the measurements may then be adjusted depending on such error. In other embodiments, the user may be notified of the error, or likelihood of error and prompted to repeat the measurement or perform another task. In this manner, further, accuracy can be estimated.

In some embodiments, which may be combined with any other embodiment, any of the measurements of the orientations, planes, or axes of the device, surfaces, or vehicle may be committed to memory or otherwise stored on the electronic device. Further, as described herein, after the measurements are stored to memory, they may be accessed and compared or otherwise manipulated for the purposes described herein. The memory, and or calculation, may be stored or executed locally or remotely, such as on another local device, on a remote server, or in the cloud. This also includes via third-party.

In one or more embodiments, which may be combined with any other embodiment, the invention may include multiple devices, such that each device can perform at least one of the described measurements. In such an embodiment, each device is able to share with any other device, either through local or remote connections, storage and sharing, or direct storage and sharing, such as via Bluetooth or Wi-Fi connections, the measurements and any associated data. Some embodiments may include a central device that receives all of the measurements and data and may perform the calculations, or additional calculations, or may display the measurements and data, such as specifications and parameters, to the user. This may include via the aforementioned GUI or via AR or VR.

In one or more embodiments, which may be combined with any other embodiment, this may include, for example, four devices which each may be attached, before or after calibration, to a respective wheel of the vehicle, such that the alignment parameters and specifications of one, multiple, or all of the wheels can be measured simultaneously, upon user direction, and/or continuously. The data and measurements for each wheel may then be viewed on another device. This may aid any adjustment of the vehicle's alignment parameters because the user is able to view the specifications as they are being adjusted and without manually placing the device at each wheel and measuring via the described. Additionally, the device the user views the data on may perform calibration steps, and/or the measurements of surfaces which determine the plane or axis which data or measurements are compared to. For example, measuring one or more surfaces of the vehicle to determine the central axis or plane of the vehicle. In other embodiments, which may be combined with any other embodiment, there may be an additional mounted or not mounted device that takes those associated measurements.

In one or more embodiments, which may be combined with any other embodiment, the present invention may include wherein parameters and specifications for a particular vehicle's alignment can be stored or saved in a remote to the device storage or database. For example, the device may access in a local network, over any LAN or internet connection, via direct connection such as Bluetooth or Wi-Fi, in the cloud or via another service, parameters and specification for a particular vehicle. These may be entered by the user or user's organization or may be sourced from any source such as a third party, subscription service, and via any method and in any other service, protocol, or format. In one or more embodiments, which may be combined with any other embodiment, the user may store and access this data manually. In other embodiments, the device may automate this process by pulling or downloading the data automatically or depending on the vehicle being aligned. This may be determined, for example, by user input of a vehicle year, make, model or via a vehicle's identification code or serial number such as a VIN. This process can be further automated, such as via scanning the vehicle's VIN with the device's camera or other methods of scanning, including connecting to the vehicle's OBD or Can Bus connection. This can include scanning QR codes, RFIDs or other codes on the vehicle which provide identification. The data can also include any type such as the vehicle alignment parameters and specification, data that allows such vehicle alignment parameters and specifications to be found or retrieved, but also data relevant to that particular vehicle including directions on how that particular vehicle's suspension geometry can be adjusted by a user. This data, again, can be retrieved based on the identifier of the vehicle and can be created or sourced from any other software, product, users, or database.

In one or more embodiments, which may be combined with any other embodiment, the device can store and access any previously saved data and compare it to the values currently being measured. This may include data the user had previously measured or stored, or may be provided by the manufacturer or any other company or location. The device and software may also include the ability to store notes about the alignment, recommendations, and or/the cause and effect of particular alignment parameters and specifications, including wherein when the specifications are out of alignment, or the effect of changing the specifications.

In one or more embodiments, which may be combined with any other embodiment the device and software may provide a walkthrough or how-to for each step of measuring the alignment parameters and specifications. This may be customized to the particular vehicle, type of alignment parameters being aligned, or may be generic. This may include the steps for measuring and/or steps to adjust the suspension or other components of the vehicle itself.

In one or more embodiments, which may be combined with any other embodiment, the device may employ filtering or other methods to reduce errors imparted by inaccuracies in the electronic device's sensors or due to limitations in processing such as sensor or calculation lag.

Any measurement can then be compared to data taken statically or dynamically prior to, at the time of measurement, or after measurement to data acquired from at least one of the electronic device's accelerometer, gyroscope, gyrometer, or barometer or any sensor on board the device including camera/photo, lidar, ultrasonic, or sonar sensors.

In some embodiments, which can be combined with any other embodiment, a lidar, laser, sonar, or other sensor which does not require contact, but which may be able to measure the disposition of a surface, either as a point measurement or as a matrix or any other measurement type. For example, instead of an protrusions of the encasement used to measure the surfaces and planes or axes herein described, it may be such that the device is held in a fashion such that a lidar sensor measures the surface, and from that measurement the plane of the surface can be determined, including in relation to the device, or such that the central axis or plane of the vehicle is determined, or that of the wheel plane or axis is determined.

In one or more embodiments, which may be combined with any other, sensors or combination of sensors can be used to determine the alignment of a vehicle's wheels without contact. This for example can include wherein lidar, ultrasonic or other similar sensors can be used to scan the vehicle with wheels, and wherein the alignment parameter specifications of the wheels in relation to the ground, vehicle, or any other known surface can be determined. For example, similar to as one takes a photo, a user can use the device's lidar sensor to scan the side of the vehicle and wherein the data from the lidar sensor can be used to determine the alignment of the wheels. This data can also be combined with any other sensor measurement or determination herein to ease the taking of an alignment or to make such data more accurate.

In one or more embodiments, which may be combined with any other embodiment, camber can be measured by taking the plane of the device or device with an encasement, wherein the plane is at a known orientation to a plane or axis of the device and wherein the user places or orients the device such that the plane matches the front plane of the wheel in such a way that the camber, i.e., the angle between the vertical plane or axis of the front face of the wheel and the vertical plane or axis of the vehicle when viewed from the front or rear of the vehicle can be measured. In other words, the angle of the front face of the wheel can be calculated or inferred from the plane of the device, wherein this change is known in the art to be known as camber.

In a preferred embodiment to find camber, the device compares the data of the plane of the wheel to that of gravity as measured by the accelerometer in the vertical orientation.

In one or more embodiments, which can be combined with any other embodiment, the aforementioned methods of normalizing a known plane can be enlisted in case the ground on the vehicle is uneven. This can be accomplished by taking measurements of the vehicle to create and store a known vertical axis of the vehicle and then comparing the measurement of the wheel's face to that of the vertical axis or plane of the vehicle instead of gravity. In another embodiment, which can be combined with any other embodiment, the normalization of the known plane can be determined by measuring the disposition of the ground the vehicle sits on. For example, the disposition of the ground can be measured by the device such that a vertical plane, at a right angle to that of the ground plane, can be created and stored as a vertical axis, such that then the measurements of the wheel can be compared to that of the ground plane. This can create a better measurement of the absolute camber value in relation to the vehicle's vertical axis than comparing to gravity since the ground, and thus vehicle, may not be situated at a perfect 90-degree angle to that of gravity.

In some examples, the measurement of the axes includes that in relation to gravity, such as being able to measure gravimetric plane(s) and comparing to that of the other measurements. This may include gravimetric yaw, roll or pitch angles. In an instance, for example, the yaw of the wheel or vehicle may be not perpendicular to that of gravity. Using sensor data and measurements, the device can determine, calculate or measure, then the yaw of the wheel or vehicle in relation to that of gravity, instead of, or in combination with, that of the vehicle or the ground. One particular example is when measuring camber and toe, wherein determining, calculating or measuring gravimetric plane may aide in determining absolute camber or toe in relation to the gravity, because the vehicle may not be perfectly situated on the ground, the suspension may have rake or compression or due to the ground not being flat. Thus, comparing measurements to the gravimetrically measured planes may allow the device to determine the camber, toe, caster or other alignment parameters specifications in relation to gravity as well as in relation to that of the frame of reference of the vehicle, vehicle chassis, frame, body, ground or any other relative measurement. Another instance where this type of normalization will be helpful is specifically when the vehicle is not on a flat surface. Thus, the measurements of toe and camber may be such that because the wheels are angled relative to the perpendicular axes to that of gravity, a toe measurement or camber measurement may then cross components in their measurement and introduce error. By determining gravimetric measurements of yaw, pitch and roll, and comparing the measurements of that of the wheel, ground, or surfaces of the vehicle, among others, this error can be negated by determining the absolute disposition of the entities in relation to gravity.

The invention described herein may allow the device to be able to set the ground plane in relation to that of gravity, and not the uneven ground the vehicle may be sitting on, or vice versa, wherein the ground plane is set to that of the ground and not gravity. In other embodiments, which may be combined with any other embodiment, the ground plane may be set in relation to other components such as to that of the vehicle, chassis, or frame. The ground frame can then be particularly used, chosen, measured, determined, or inferred depending on the particular measurement, calculation, or inference, alignment parameter output, etc.

In one or more embodiments, which may be combined with any other embodiment, when taking a measurement, such as a surface measurement, the device may require, inform, or direct the user to orient the disposition of the device in such a way that the measurement is taken in a certain disposition. For example, when taking the disposition measurement of a surface, the device can inform the user via any method, such as cross hairs, a bubble or arrows, to align the device in a particular orientation to that of gravity, i.e., “flat”. Thus, this can limit errors or improper measurements in terms of measurement for particular dispositions of a surface, such as for the aforementioned gravimetric yaw. This example is not limiting and its principle can be applied to any measurement discussed herein, and is not limited to that of gravity but can also be applied to that for previous measurements. For example, the device can initially measure a disposition of the ground surface, or for example vehicle rake, and then subsequent measurements can use that as a reference.

In other embodiments, which may be combined with any other embodiment, the device may be placed on, or include, a long and flat bar, such that the bar may be placed on the ground and reduce inconsistency of the ground surface such that a more accurate measurement can be completed. This bar can be made out of any material, such as wood, plastic, metal or any other. The bar can include wherein the device, with or without encasement, can be placed on a surface, for example, a top surface, or may captivate or otherwise hold the device or encasement. Further, instead or additionally, the encasement can be shaped or formed such to include surfaces or protrusions, which may be adjusted, such that an accurate measurement of the ground and ground plane can be accomplished. In some embodiments, which may be combined with any other embodiment, this method can also be used instead to produce a sanity check or otherwise filter inaccurate data. Further, a separate spirit or bubble level can be used to determine the ground plane, wherein data from the level is inputted into the device, or wherein the spirit level is used to find a particular flat ground for the vehicle to rest on, or wherein the spirit level is used as the long and flat bar such to reduce inconsistency of the surface, and to make sure the ground is in fact level when taking the ground plane measurement.

In one or more embodiments, toe can be measured by taking the plane of the device or device with an encasement, wherein the plane is at a known orientation to a plane or axis of the device and wherein the user places or orients the device in space such that the plane matches the face of the wheel, such that the face or surface of the wheel can be calculated or inferred from the plane of the device. This calculation or inference can be the difference in the angle of the front face or plane of the wheel and that of the central axis or plane of the vehicle previously calculated. For example, it may be the difference between the angle of the front face of the wheel and the longitudinal axis or plane of the vehicle. Another example may include wherein toe may be the difference between the angle of the front face of the wheel and the plane parallel to the forward direction of the vehicle.

An embodiment, which may be combined with any other embodiment, may also calculate the “total toe” of the vehicle, wherein the aforementioned toe is taken for each of the wheels for an axle (i.e., the two front or two rear wheels), and the two angles are subtracted, such that the total toe of that axle is known.

In one or more embodiments, which may be combined with any other embodiment, the caster can be measured combining the methods, apparatuses, and systems described for taking the camber and toe. In one or more embodiments, wherein the central axis or plane of the vehicle is measured and known in relation to the central axis or plane of the device, camber is taken when the wheels are straight. Then, the wheels are turned in one direction and held or otherwise kept in place. The device can then take what would be a toe measurement, but instead, this is to store the angle for which the wheel has been turned. Then, the user may take the camber angle. This can be repeated in the other direction. The invention can then calculate the caster angle. This method has advantages over prior embodiments because the turning axis of the wheel does not need to be known or measured by the user using a separate device, such as through the use of a turnplate. Further, because the exact angle of the vehicle's wheels is accurately measured, instead of, for example, using turnplates, which have a margin of error, the calculated caster angle will be highly accurate. In one or more embodiments, turnplates or other devices may be able to manually measure the angle of the wheel. In one or more embodiments, the device or devices may be secured to the wheel and allowed to read a full sweep of the wheel's toe and camber angle as the wheel turns on its steering axis, or any other axis.

In some embodiments, which may be combined with any other embodiment, data from other measuring devices, apparatuses or systems can be inputted into the present invention system either manually, such as via a user entering the data via the device touchscreen or automatically, such as the data being inputted via an automated script or via the user uploading a dataset, such that the data is then read. This can, for example, be measurement data such as from a ruler or angles from a turnplate.

In one or more embodiments, which may be combined with any other embodiment, the invention may also include the ability to measure and calculate Ackermann angle. For example, the device can take an initial toe measurement with the wheels straight. Then, the user can turn the wheels one way and subsequently take the front left and front right toe angles. The invention can then calculate an effective Ackermann angle.

Further, it can be understood that the alignment parameters described herein can be used to then calculate other alignment parameters. For example, bump steer can be measured, calculated, or inferred through the described ability to measure toe but additionally multiple times through the cycling of a suspension. Another example includes thrust angle which can be calculated or inferred from the taking of toe for multiple of the vehicles' wheels. Steering axis inclination can be determined by taking a camber measurement, as well as a similar measurement to that of the strut or suspension component being measured.

In an example embodiment, which may be combined with any other embodiment, the device may be able to determine the wheel the measurement device or devices are located at or proximate to. The device may do this through a measurement or comparison of its connection to any other device, whether that device is on or off the vehicle. For example, this may include Wi-Fi strength (such as RSSI) to that of a home network off the vehicle or Wi-Fi signal emanating from the vehicle, GPS, or through the use of the sensors or sensor suites, such as accelerometer or gyrometer. This can also include triangulating the location of the device. For example, this can include wherein the user first is instructed, or enters in, a particular wheel, some wheels, or all wheels to have an initial measurement to be taken. For example, the device can inform the user to walk to the front left wheel and place the device up against the wheel and then the back right wheel and place the device against the wheel, such that the Wi-Fi RSSI is read when the device is at each wheel, and from there the device can determine the location of the device in relation to all four wheels. This reading can also be taken alongside any other reading, such as combined with or at the same time of a reading of a surface herein described elsewhere. This example can also include wherein the device is placed against all four wheels as well, or any other number wherein the device is able to then determine the data necessary to later determine its location. This can also include wherein the device measures or calculates its error or confidence to being at a particular wheel and can notify the user to confirm the wheel, or otherwise notify the user of such a possible error such that the user can manually input the wheel if the device is mistaken. This feature may include wherein the device can also determine the location through methods such as reading or measuring strength from one or multiple tire pressure sensors, or any other device, such as Bluetooth from the vehicle's head unit, among others.

Although the present embodiments have been described with reference to specific example embodiments, it will be evident that various modifications and changes may be made to these embodiments without departing from the broader spirit and scope of the various embodiments. It should be understood by persons of ordinary skill in the art that the terms describing processes, products, elements, or methods are industry terms and may refer to similar alternatives. In addition, the components shown in the figures, their connections, couples, and relationships, and their functions are meant to be exemplary only and are not meant to limit the embodiments described herein.

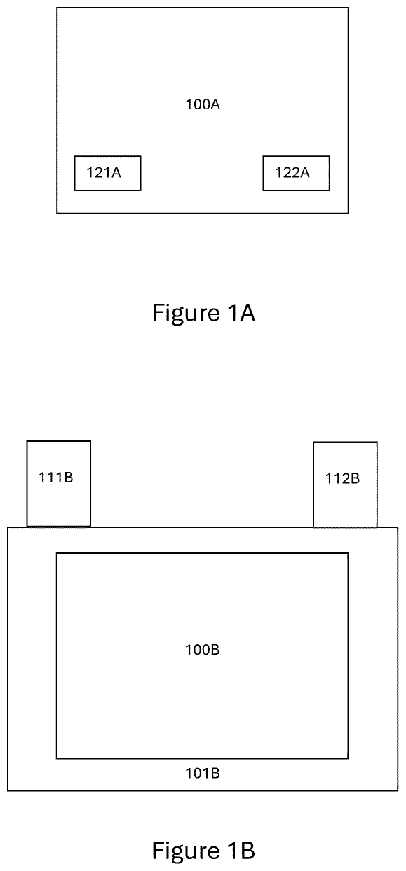

FIG. 1A is a component view of one embodiment of the present invention alignment system, apparatus and method, particularly the electronic device.

Device 100A may be the device herein described. Component 121A and Component 121B may be sensors herein described, such as an accelerometer and gyroscope. Components 121A and 121B can be any multitude of components such as any other sensors. Further, the sensors can be in any location on or internal to the Device 100A. The one or more components' positions relative to a known point, axis or plane in respect to Device 100A can be known or unknown.

FIG. 1B is a component view of one embodiment of the present invention alignment system, apparatus and method, particularly the electronic device in an encasement.

Device 100B may be encased in an Encasement 101B that includes one or more protrusions such as Protrusions 111B and 112B. The encasement can include the features herein described and may otherwise hold Device 100B such that the Protrusions 111B and 112B, or the axes or planes they create, are at a known disposition to the Device 100B.

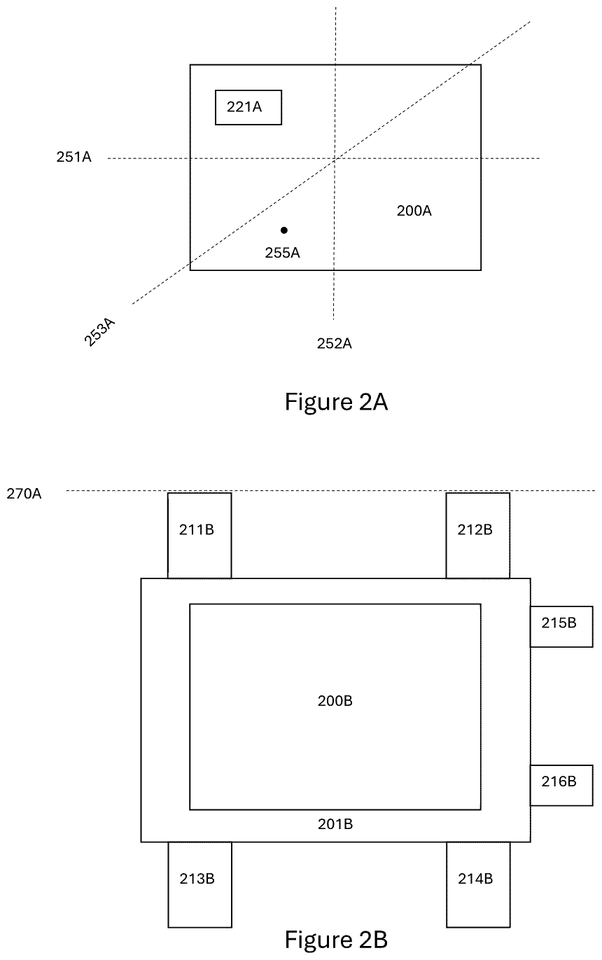

FIG. 2A is a component view of one embodiment of the present invention alignment system, apparatus and method, particularly the electronic device with axes and planes.

Device 200A may include one or more Components 221A, which may be a sensor. The components, such as Component 221A, may be at a known disposition to the one or more of the axes or planes of the device, such as Axis 251A, which may, for example, be a longitudinal axis, Axis 252A which may, for example, be a latitudinal axis, and/or Axis 253A which may be a vertical axis. Instead of an axis, there may be one or more points 255A.

FIG. 2B is a component view of one embodiment of the present invention alignment system, apparatus and method, particularly the electronic device in an encasement with protrusions and with labeled axes and planes.

Device 200B may be encased in Encasement 201B that includes one or more protrusions such as Protrusions 211B and 212B. The encasement can include the features herein described and may otherwise hold the device 200B such that the Protrusions 211B 212B, 213B and 214B, or the axes or planes they create, are at a known disposition to the Device 200B. For example, Protrusions 211B and 212B may create a Plane 270A which may be at a known disposition to the Device 200B. Further, this can be instead at a known disposition to a sensor in Device 200B such as that described herein such as for FIG. 2A. Further, it is noted that Protrusions 211B and 212B being on opposite sides of the Device 200B and Encasement 201B allow for the device to be minimally rotated when taking measurements on each side of a vehicle, such that Protrusions 211B and 212B can be used to measure the surface of one side of a vehicle, and therein Protrusions 213B and 214B can then take the measurement of a surface on the other side of a vehicle. Further, an embodiment could also include Protrusions 215B and 216B which could be used to take surface measurements on the rear of a vehicle without the Device 200B and Encasement 201B being rotated.

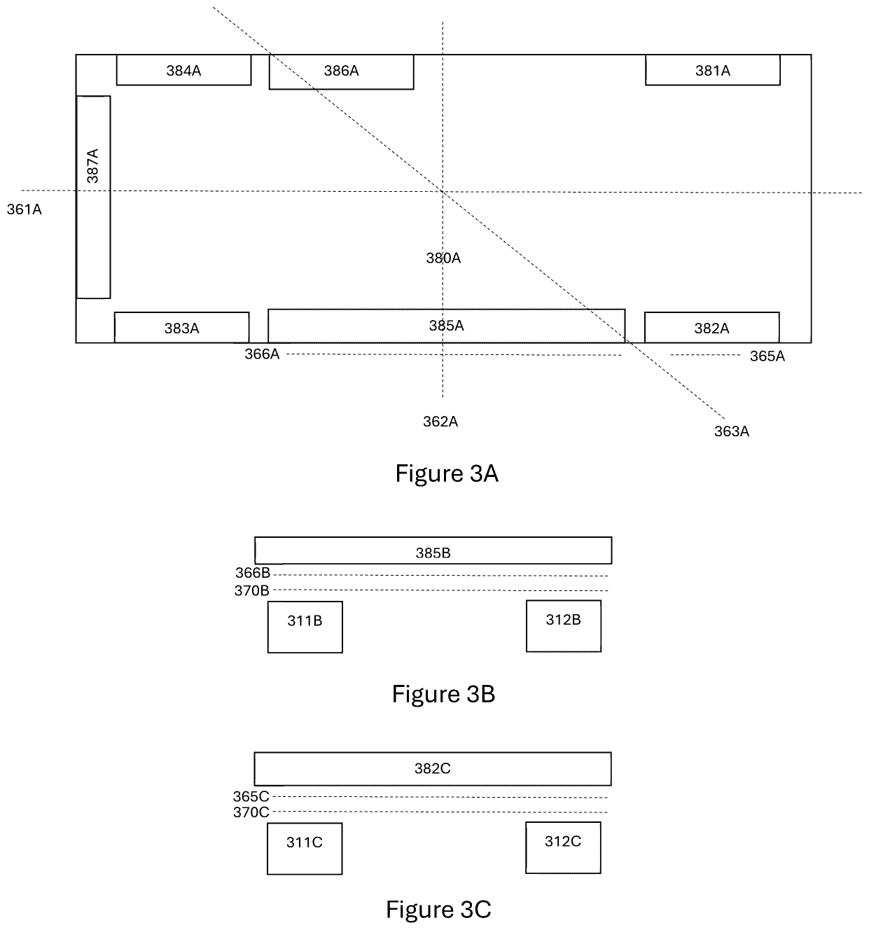

FIG. 3A is a component view of one embodiment of the present invention alignment system, apparatus and method, particularly a vehicle with labeled axes and planes.

FIG. 3A shows a Vehicle 380A which may have Wheels 381A, 382A, 383A, and 384A. Further, Vehicle 380A may have any number of surfaces, such as Surfaces 385A, 386A, and 387A. Each wheel may have a plane, such as a front plane, or a plane parallel to its rotational axis such as Wheel Plane 365A. Additionally, the vehicle surfaces herein described may be any vehicle surface. For example, Surface 385A may be the surface of the vehicle door or fender and may have a corresponding Plane 366A. Other examples include Surface 386A may be the opposite side surface of the vehicle door or fender, or may be, for example, a window. Further, the vehicle surface can also be perpendicular or at any angle to that of the direction of the vehicle such as Surface 387A. The vehicle may also then have any number of axes or planes that may be determined through the one or multiple measurements of the surfaces, such as a Central Axis or Plane 361A, which may parallel to the forward direction of the vehicle's body or chassis. Therein may also be other axes or planes such as 362A or 363A for which can be determined, calculated, or measured.

FIG. 3B is a component view of one embodiment of the present invention alignment system, apparatus and method, particularly a surface of a vehicle and device protrusions with labeled axes and planes.

As an example, Plane 366B of a Surface 385B, such as that of a vehicle surface, is able to be measured, calculated, or determined by positioning protrusions of a device described herein, such as Protrusions 311B and 312B, wherein then the device is able to measure or impart the Plane 370B of Protrusions 311B and 312B to that of the Surface 385B and Plane 366B, such that the disposition of the Surface 385B and Plane 366B is determined or known.

FIG. 3C is a component view of one embodiment of the present invention alignment system, apparatus and method, particularly a surface of a wheel and device protrusions with labeled axes and planes.

As an example, Plane 365C of a Surface 382C, such as that of a vehicle surface, is able to be measured, calculated, or determined by positioning protrusions of a device described herein, such as Protrusions 311C and 312C, wherein then the device is able to measure or impart the Plane 370C of Protrusions 311C and 312C to that of the Surface 382C and Plane 365C, such that the disposition of the Surface 382C and Plane 365C is determined or known.

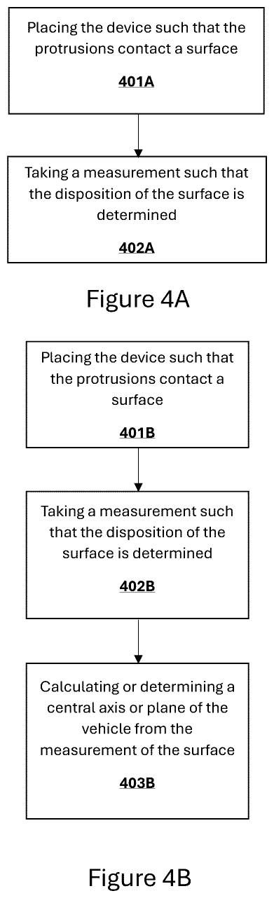

FIG. 4A is a flow chart view of one embodiment of the present invention alignment system, apparatus and method.

Step 401A includes, for example, placing the device such that the protrusions contact a surface. Step 402A includes, for example, taking a measurement such that the disposition of the surface is determined.

FIG. 4B is a flow chart view of one embodiment of the present invention alignment system, apparatus and method. Step 401B includes, for example, placing the device such that the protrusions contact a surface. Step 402B includes, for example, taking a measurement such that the disposition of the surface is determined. Step 403B includes, for example, calculating or determining a central axis or plane of the vehicle from the measurement of the surface.

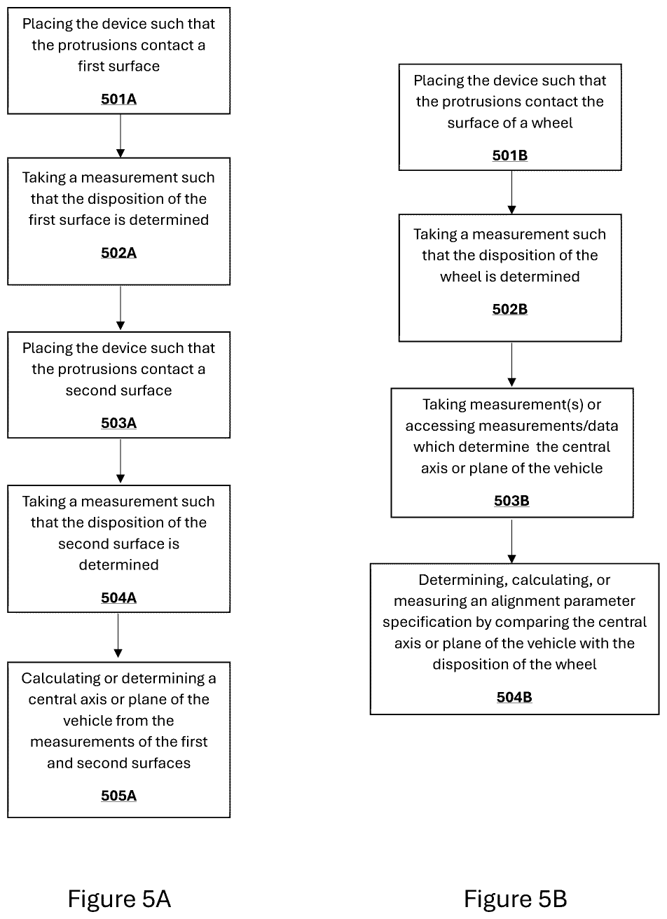

FIG. 5A is a flow chart view of one embodiment of the present invention alignment system, apparatus and method. Step 501A includes, for example, placing the device such that the protrusions contact a first surface. Step 502A includes, for example, taking a measurement such that the disposition of the first surface is determined. Step 503A includes, for example, placing the device such that the protrusions contact a second surface. Step 504A includes, for example, taking a measurement such that the disposition of the second surface is determined. Step 505A includes, for example, calculating or determining a central axis or plane of the vehicle from the measurements of the first and second surfaces.

FIG. 5B is a flow chart view of one embodiment of the present invention alignment system, apparatus and method. Step 501B includes, for example, placing the device such that the protrusions contact the surface of a wheel. Step 502B includes, for example, taking a measurement such that the disposition of the wheel is determined. Step 503B includes, for example, taking measurement(s) or accessing measurements/data which determine the central axis or plane of the vehicle. Step 504B includes, for example, determining, calculating, or measuring an alignment parameter specification by comparing the central axis or plane of the vehicle with the disposition of the wheel.

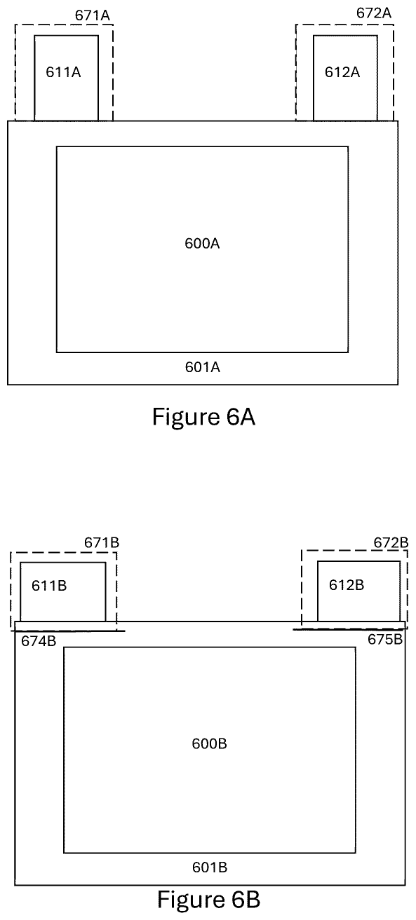

FIG. 6A is a component view of one embodiment of the present invention alignment system, apparatus and method, particularly the electronic device in an encasement with protrusions and covers for said protrusions.

Device 600A may be encased in Encasement 601A that includes one or more protrusions such as Protrusions 611A and 612A. The encasement can also include wherein sleeves or covers for the protrusions, such as wherein Protrusions 611A and 612A can be covered by Covers or Sleeves 671A and 672A respectively. The covers or sleeves can be inserted or attached from any direction onto the protrusions of the encasement. Further, the sleeves or covers in some embodiments can encase the entire device.

FIG. 6B is a component view of one embodiment of the present invention alignment system, apparatus and method, particularly the electronic device in an encasement with protrusions and covers for said protrusions.

Device 600B may be encased in Encasement 601B that includes one or more protrusions such as Protrusions 611B and 612B. The encasement can also include wherein sleeves or covers for the protrusions, such as wherein Protrusions 611B and 612B can be covered by Covers or Sleeves 671B and 672B respectively. The covers or sleeves can be inserted or attached from any direction onto the protrusions of the encasement. The encasement can have grooves, slots, or indents, such as slot 674B and 675B, that can allow the sleeve or cover to encase the protrusions, or a particular area of the protrusion.

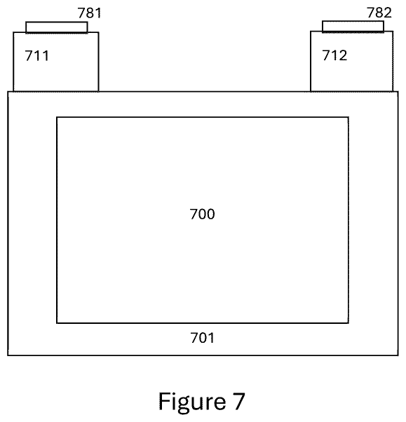

FIG. 7 is a component view of one embodiment of the present invention alignment system, apparatus and method, particularly the electronic device in an encasement with protrusions.

Device 700 may be encased in Encasement 701 that includes one or more protrusions such as Protrusions 711 and 712. The protrusions may be of any geometry, including wherein the protrusions may have additional extrusions, such as Extrusions 781 and 782 respectively. These extrusions may be of any thickness, width, or shape which may aide in the proper contact with the surface to be measured. For example, specifically where the surface of the surface to be measured is of a shape that is difficult for the contact to be made squarely with the surface. This includes wherein the wheels have a dish or other angled surface face or may be such that he wheel does not present an easily accessible flat front face or where the structure or design of the wheel makes access to such a face difficult. The protrusions may be shaped such that the contact can be repeatable an otherwise uniform or parallel and such that the encasement can be positioned to be flat or at a particular position or placement in respective to a particular plane of the surface to be measured or any other surface.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated from the described flows, and other components may be added to or removed from the described systems. Accordingly, other embodiments are within the scope of the following claims.

It may be appreciated that the various systems, methods, and apparatuses disclosed herein may be embodied in a machine-readable medium and/or a machine-accessible medium compatible with a data processing system (e.g., a computer system) and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. A wheel alignment system comprising:
an encasement, wherein the encasement includes:
one or more protrusions;
a handheld device, wherein the handheld device is encased in the encasement and includes:
a display and a user interface;
an operating system and software;
sensor data from one or more sensors;
and wherein the handheld device and encasement are able to:
take a measurement of a surface using the one or more protrusions and the one or more sensors such that a disposition of the measured surface can be determined in relation to a disposition of the handheld device and encasement; and
determine one or more measurement specifications.

2. The system of claim 1, wherein the handheld device and encasement are able to additionally:
take any number of subsequent additional measurements of a surface, wherein the additional measurements are used to determine and mitigate error.

3. The system of claim 1, wherein the handheld device and encasement are able to additionally:
take any number of subsequent additional measurements of a surface, wherein the additional measurements are used to determine a change in disposition of the measured surface and results in the determination of the one or more measurement specifications.

4. The system of claim 1, wherein the handheld device and encasement are able to additionally:
take any number of measurements of one or more additional surfaces.

5. The system of claim 4, wherein the handheld device and encasement are able to additionally:
determine a difference in disposition between the measurements of any of the measured surfaces which results in the determination of the one or more measurement specifications.

6. The system of claim 1, wherein the measurement specification is the difference in angle between the measurement of a surface and that of data from a sensor.

7. The system of claim 1, wherein disposition includes the orientation or angle in 2D or 3D space.

8. The system of claim 1, wherein disposition includes the position in 2D or 3D space.

9. The system of claim 1, wherein the one or more sensors include at least one of the following:
gyroscope;
accelerometer;
gyrometer;
compass;
magnetometer;
camera;
barometer;
pressure sensor;
hall sensor;
proximity sensor;
lidar sensor
camera sensor;
sonar sensor;
ultrasonic sensor; or
gps sensor.

10. The system of claim 1, wherein the sensors are able to measure in any number of axes.

11. The system of claim 1, wherein the handheld device is a mobile phone or tablet.

12. The system of claim 1, wherein the surface measured is at least one of the following:
the exterior surface of a vehicle;
the surface of a wheel;
a vehicle frame or chassis rail.

13. The system of claim 1, wherein the protrusions are positioned such that they can make contact with a surface to be measured.

14. The system of claim 1, wherein the one or more protrusions have one or more extrusions of a geometry that aides in the contact of the surface to be measured.

15. The system of claim 1, wherein the protrusions have a sleeve or cover.

16. The system of claim 15, wherein the sleeve or cover reduces scratching between the protrusions and a surface to be measured.

17. The system of claim 15, wherein the sleeve or cover is made of a thermoplastic such as polyolefin.

18. The system of claim 1, wherein the determined measurement specifications include at least one of:
camber;
toe;
caster;
Ackermann;
thrust angle;
bump steer;
steering axis inclination;
scrub radius.

19. The system in claim 1, wherein the handheld device and encasement are able to additionally:
filter the data from the one or more sensors such that particular characteristics of the data, including sensor error, can be mitigated.

20. The system in claim 1, when the handheld device and encasement are able to additionally:
predict error when the measurement specifications are determined and remove the error from the determined measurement specifications.
